(19) United States
(12) Patent Application Publication
(10) Pub. No.: US 2018/0022530 A1
(43) Pub. Date: Jan. 25, 2018

(54) PACKAGING DEVICE FOR A PRODUCT TO BE DISPENSED

(71) Applicant: LOUIS VUITTON MALLETIER, Paris (FR)

(72) Inventors: Céline DUPONT, Colmbes (CH); Aurélie SEURAT, Levallois-perret (FR); Bénédicte GORY, Paris (FR); Delphine BILLEBEAU, Bezons (FR)

(73) Assignee: LOUIS VUITTON MALLETIER, Paris (FR)

(21) Appl. No.: 15/549,960

(22) PCT Filed: Feb. 9, 2016
(86) PCT No.: PCT/FR2016/050288

§ 371 Date: Aug. 9, 2017

(30) Foreign Application Priority Data
Feb. 10, 2015 (FR) 15 51067

(51) Int. Cl. B65D 83/00; B05B 11/00

(52) U.S. Cl. CPC B65D 83/0022; B05B 11/3001; B05B 11/3049; B05B 11/0013

(57) ABSTRACT

The invention relates to a packaging device for a product to be dispensed, comprising a bottle suitable for containing the product to be dispensed and having a neck comprising an inner wall delimiting an opening, a dispensing device comprising a body and suitable for dispensing said product, a fastening element for securing the body of the dispensing device in the neck of the bottle, the fastening element cooperating with the inner wall of the neck of the bottle. The device is noteworthy in that the fastening element comprises an internal hollow shaft and in that said dispensing device comprises a fastening member of said dispensing device, the fastening member being integral with said dispensing device and being fixed around the internal hollow shaft of the fastening element.

The invention relates to packaging devices for a product to be dispensed, and in particular to bottles having a neck equipped with a dispensing device, for example a pump.

Such packaging devices for a product to be dispensed are known, comprising:
a bottle suitable for containing the product to be dispensed and having a neck comprising an inner wall delimiting an opening,
a dispensing device comprising a body and suitable for dispensing said product.

Depending on the type of dispensing device and depending on the shape and dimensions of the neck of the bottle, it is sometimes necessary to provide a fastening element for securing the body of the dispensing device in the neck of the bottle.

To do this, the fastening element is designed to cooperate with the inner wall of the neck of the bottle.

The dispensing devices and in particular the pumps associated with the fastening elements are usually “plug”-type pumps, inserted by force into the fastening element which itself is inserted into the neck of the bottle.

The invention aims to offer an alternative packaging device which comprises a dispensing device other than a “plug”-type pump and which ensures the securing of the device in the neck of the container.

Moreover, the invention proposes a packaging device which, for aesthetic reasons, allows hiding the body of the dispensing device.

For this purpose, it proposes a packaging device comprising, in the conventional manner, a bottle suitable for containing the product to be dispensed and having a neck comprising an inner wall delimiting an opening, a dispensing device comprising a body and suitable for dispensing said product, and a fastening element for securing the body of the dispensing device in the neck of the bottle.

The device is noteworthy in that the fastening element comprises a cylindrical double wall comprising an outer wall and an inner wall forming an internal hollow shaft, said outer and inner walls being coaxial, and in that said dispensing device comprises a fastening member of said dispensing device, the fastening member being integral with said dispensing device and being fixed around the internal hollow shaft of the fastening element.

The presence of a hollow shaft internal to the fastening element makes it possible to secure the fastening member integral with the body of the dispensing device. This fastening hollow shaft may have substantially the same shape and dimensions as the small necks conventionally used on perfume bottles for the attachment of pumps by press-fitting, crimping, or screwing them on. Crimp-on, press-fit, or screw-on dispensing devices can thus be attached very simply to the internal hollow shafts of the fastening elements without needing to make structural modifications to these pumps. In this manner, the invention allows attaching pumps that are different from “plug”-type pumps.

Furthermore, when implemented in this manner, the pump body is hidden in the fastening element, which hides the body of the dispensing device and satisfies aesthetic requirements concerning the bottle.

The invention may also include the following features, separately or in combination:
the inner and outer walls have a common end integral to a cylinder which is coaxial with said walls and which extends downwards,
the internal hollow shaft has a retaining element for the fastening member,
the retaining element is a bead formed substantially around the hollow shaft,
the retaining element is formed by radial projections uniformly distributed around the axis of the hollow shaft,
the fastening member is crimped around the internal hollow shaft,
the fastening member comprises at least one internal fastening projection, for securing the dispensing device around the internal hollow shaft,
said at least one internal fastening projection is formed on an inner face of a ring with radial sections, said ring with radial sections constituting said fastening member and being secured around said body of said dispensing device,
the fastening element comprises a cylinder forming a cover for the body of the dispensing device, the cylinder being coaxial with the neck and extending to a height able to conceal said body in the neck,
the neck has a neck height, and the cylinder extends along the entire neck height,
the cylinder has a diameter such that there is empty space between the cylinder and the inner wall of the neck,
the fastening element supports a radial O-ring,
the radial O-ring is fitted around the fastening element,
the fastening device has a radial groove into which the radial O-ring is inserted,
the fastening element comprises a radially projecting flange, said flange comprising a lower surface facing a shoulder provided at the end of the neck,
the device further comprises a flange seal located between the flange and the neck,
an adhesive is placed between the seal and the flange seal to bond the fastening element to the neck,
the neck comprises a snap-fitting groove on its inner face, and the fastening element comprises clips facing said snap-fitting groove in order to engage with the snap-fitting groove,
the snap-fitting groove is formed in the neck by laser,
the device further comprises a ring force-fitted between the dispensing device and the fastening element,
the ring is located between the outer and inner walls of the fastening element.

The invention is set forth in the following description in a sufficiently clear and complete manner to enable its implementation, accompanied by drawings in which:

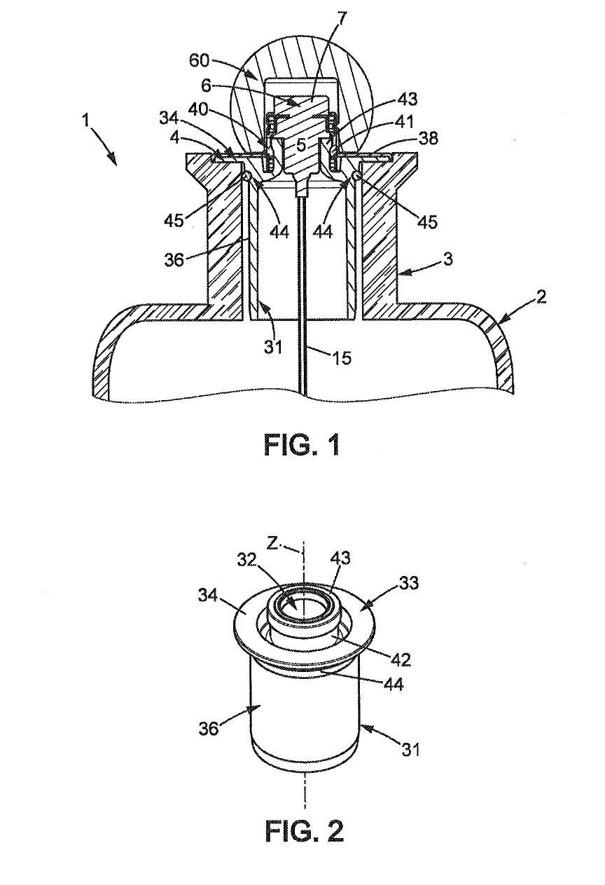

FIG. 1 is a cross-sectional schematic view of a neck of a packaging device, partially represented, according to a first embodiment of the invention, the neck comprising a “press-fitted pump” type of dispensing device inserted into a fastening element;

FIG. 2 is a perspective view of the fastening element shown in FIG. 1;

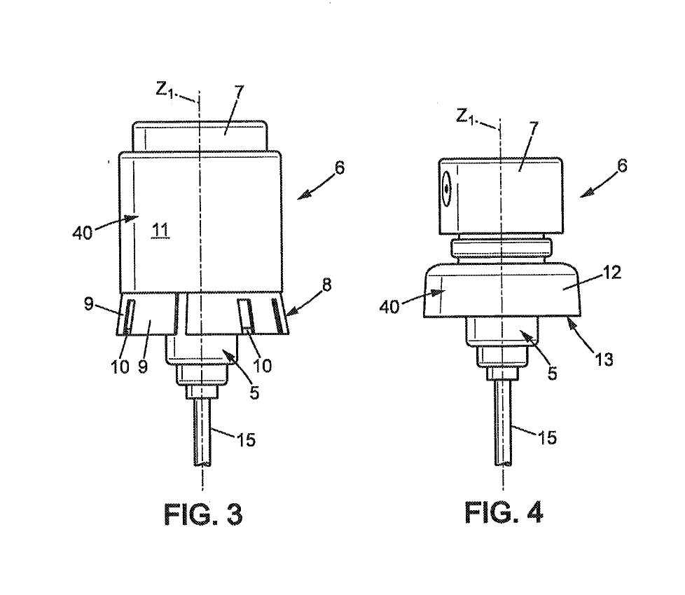

FIG. 3 is a side view of a first model of dispensing device, of the “press-fit pump” type;

FIG. 4 is a side view of a second model of dispensing device, of the “crimp-on pump” type;

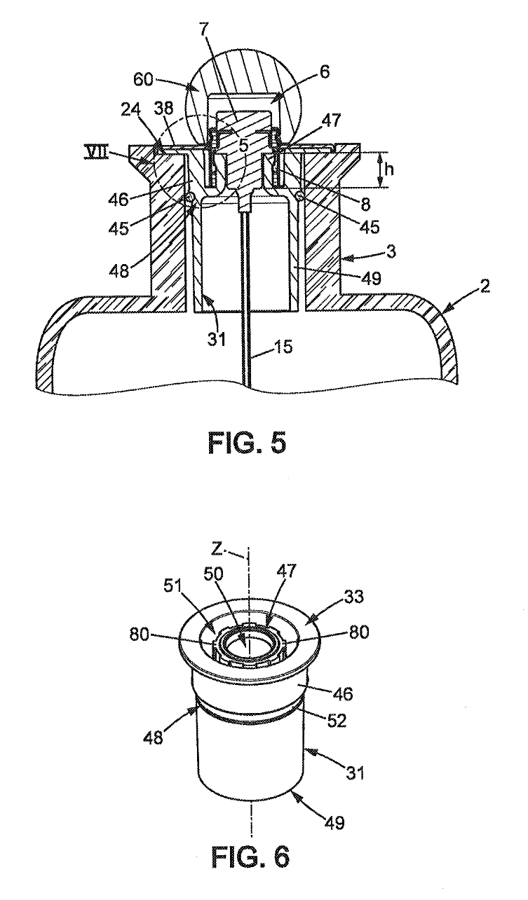

FIG. 5 is a cross-sectional schematic view of a neck of a packaging device, partially represented, according to a second embodiment of the invention, the neck comprising a dispensing device inserted into a fastening element;

FIG. 6 is a perspective view of the fastening element shown in FIG. 5;

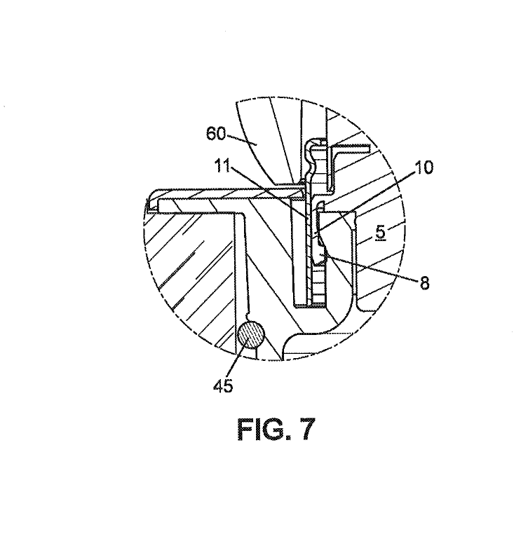

FIG. 7 is an enlargement of area VII shown in FIG. 5; and

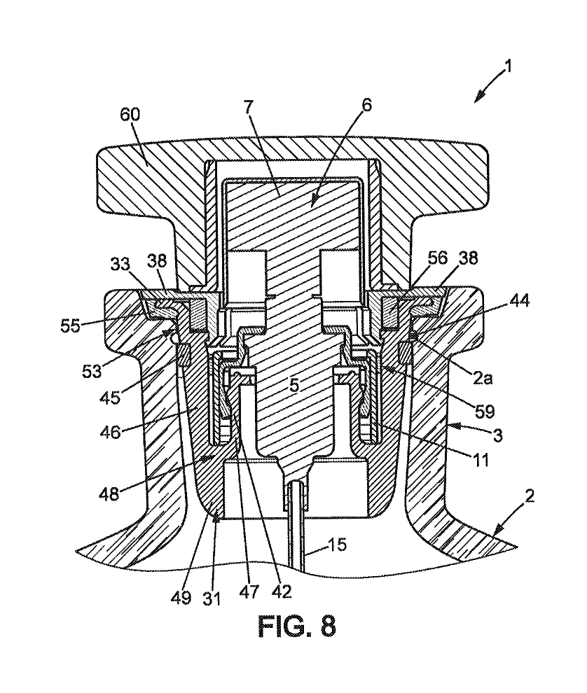

FIG. 8 is a cross-sectional view of another example of a neck of a packaging device, partially represented, according to the second embodiment of the invention.

In the following description, the terms “lower”, “upper”, “bottom”, “top”, etc. are used in reference to the drawings for greater ease of understanding. They should not be construed as limitations to the scope of the invention.

In addition, references designating the same elements have been maintained from one figure to another to facilitate viewing, even when these elements may have different shapes.

FIG. 1 shows a first exemplary embodiment of a packaging device 1 according to the invention.

The packaging device 1 comprises a bottle 2, for example transparent or translucent, made of glass and formed of a glass body defining a reservoir suitable for containing a fluid or liquid product such as perfume, for example. The bottle could also be made of another material such as plastic or Surlyn®.

The glass bottle 2 comprises an integral neck 3, forming an opening in the bottle.

The neck 3 has at least one internal shoulder 4 to enable functional assembly of a portion of a fastening element 31 of a body 5 of a dispensing device 6.

The dispensing device 6 is a “pump”-type device. In addition to the pump body 5, the dispensing device 6 comprises a head 7 formed by a pushbutton, and a dip tube 15 suitable for withdrawing fluid contained in the bottle 2.

The body 5 of the dispensing device 6 is inserted into the fastening element 31, which itself is inserted into the neck 3 of the bottle 2.

The fastening element 31 (also called a ferrule or cover), shown in FIG. 2, is a part that is rotationally symmetrical about a vertical axis Z, the part being substantially cylindrical in shape and traversed by a channel 32, suitable for accepting the pump body 5 of the dispensing device 6. The outer diameter of the fastening element 31 is sized to allow its insertion into the neck 3 of the bottle 2.

The fastening element 31 allows not only securing the dispensing device 6 in the neck 3 of the bottle 2, but also allows hiding the body 5 of the dispensing device 6.

In addition, the fastening element 31 when so arranged can be wholly contained within the neck 3 of the bottle 2, without covering its outer surface as is the case in conventional bottles equipped with a neck covered by a pump. This provides an aesthetic advantage, as the neck 3 of the bottle 2 of the device according to the invention is without any additional part that hides it.

In its upper portion, the fastening element 31 provides a radially projecting flange 33 having two substantially flat upper and lower surfaces 34. The function of the flange 33 is to bear, by means of its inner surface 34, against the inner surface of the shoulder 4 formed at the end of the neck 3 of the container. For this purpose, the outer diameter of the flange is greater than the inner diameter of the neck 3.

The flange 33 thus acts as a stop when the fastening element 31 is inserted into the neck 3 of the container, ensuring proper positioning of the fastening element 31 in the neck 3.

The flange 33 is attached to the shoulder 4, for example by bonding, and in particular by UV bonding. It is understood that the attachment of the flange 33 could also be done in some other manner (for example by hot-melt adhesion if the bottle is not transparent).

In this exemplary embodiment, the fastening element 31 is made of a rigid material such as polypropylene, ensuring that the manufacturing tolerances are reduced so that the fastening element 31 is perfectly adapted for insertion into the neck 3. However, it could also be made of a material that is sufficiently flexible to be capable of slight deformation or compression for insertion into the neck 3 of the container, even when it is already equipped with the dispensing device 6. This material may be a flexible plastic or a deformable material such as rubber or silicone.

Under the radially projecting flange 33, the fastening element 31 has a substantially cylindrical skirt 36 of substantially constant diameter, or slightly tapered to facilitate removal, and which extends along substantially the entire height of the neck 3 of the bottle 2 (see FIG. 1).

The fastening element 31 has been designed for the insertion of pump-type dispensing devices 6.

Two embodiments of the pumps are schematically illustrated in FIGS. 3 and 4.

FIG. 3 schematically represents a “press-fitted pump” type of dispensing device 6 comprising a pushbutton 7, connected to a pump body 5, which itself is connected to a dip tube 15.

The pump body 5 is secured to a ring 8 with radial sections 9 uniformly distributed around the axis Z1 of the pump 6.

The ring 8 is made of a flexible material: the radial sections 9 can thus be directed towards the inside of the ring 8 by simple external pressure on the ring 8. Each of the radial sections comprises an internal projection 10.

The head of the pump 6 shown in FIG. 3 also comprises a movable skirt 11 formed by a hollow cylinder, movable in the axial direction of the pump (from top to bottom in FIG. 3). By displacing the movable skirt 11 towards the ring 8 with radial sections 9, external pressure is exerted on each of the radial sections 9, which deforms the radial sections 9 and urges them towards the axis Z1 of the pump 6.

FIG. 4 shows another dispensing device 6, of the “crimped pump 6” type.

The pump 6 shown in FIG. 4 comprises a pushbutton 7, connected to a pump body 5, which itself is connected to a dip tube 15.

The pump body 5 is also integral with a coaxial skirt 12 that is substantially cylindrical and flares downward (away from the pushbutton 7). The skirt 12 is made of a deformable material such as aluminum. The skirt 12 is sometimes referred to as an “aluminum collar”. This pump is fastened to a neck by crimping, meaning by deformation of the deformable skirt 12 onto the neck. This deformation results in an irreversible attachment.

According to another embodiment (not shown), the pump may be of the “screw-on pump” type.

FIGS. 1 and 5 show press-fitted pumps fixed to fastening elements 31.

In FIG. 1, the movable cylindrical skirt 11 and the ring 8 with radial sections 9 are schematically represented by a cylindrical skirt denoted 40 which extends axially around the pump body 5 and which has an internal shoulder 41 (or internal bead).

The cylindrical skirt 40 and its internal shoulder 41 constitute a fastening member for the dispensing device 6, and this member is integral with the body of the dispensing device 6.

For the pump shown in FIG. 3, the internal shoulder 41 corresponds to the projections 10 of the radial sections of the ring 8.

FIG. 7 shows an enlargement of the fastening means of a pump 6 to be press-fitted onto another fastening element 31, as will be seen further below.

In FIG. 2, the fastening element 31 comprises a coaxial internal hollow shaft 42 (see FIG. 2) comprising a bead 43 at its upper end, the hollow shaft 42 and the bead 43 having dimensions such that the skirt 40 of the dispensing device 6 can be secured around it, for example an outside diameter of about 13 mm. The dimensions of this hollow shaft 42 are therefore approximately the dimensions of the necks of perfume bottles conventionally used with press-fit or crimp-on pumps. Thus, the fastening element 31 serves an adapter function enabling attachment of a conventional pump, intended for a neck having a diameter of about 10 to 15 mm, to a bottle having a neck of much larger diameter, for example at least two or three times larger.

In order to ensure a good seal between the fastening element 31 and the inner surface of the wall of the neck 3 of the bottle, the fastening element 31 has a radial groove 44, formed under the flange 33, for receiving an O-ring seal (shown in FIG. 1).

The O-ring 45 is of larger cross-section than the depth of the radial groove 44 so that a portion of the O-ring 45 protrudes from the surface of the fastening element 31 when the O-ring 45 is inserted into the groove 44. This allows flattening the O-ring 45 on the inner surface of the neck 3, thus creating a seal between the fastening element 31 and the inside of the neck 3.

In order to lock the positioning and conceal the flange 33 of the fastening element 31 after insertion of the latter into the neck 3 of the bottle, a flat locking ring 38 is provided (FIG. 1).

The flat locking ring 38 is able to envelop the flange 33 and possibly a portion of the dispensing device 6 in order to secure it to the flange 33. The flat locking ring 38 also serves an aesthetic function.

The device shown in FIG. 1 further comprises a cover 60 (or cap) to cover the dispensing device 6 and protect it, or to avoid unintentional pressure on the dispensing device 6 which would cause accidental actuation of the pump.

In a device according to the invention implemented in this manner, note that the fastening element 31 is positioned around the hollow shaft 42 but inside the neck 3, meaning between the inner wall of the neck 3 of the bottle and the hollow shaft 42.

Another embodiment is illustrated in FIGS. 5, 6, 7, and 8.

It relates to another embodiment of the fastening element 31 in particular.

The fastening element 31 also allows receiving and concealing a dispensing device 6.

However, the fastening element 31 allows placing the pushbutton 7 of the dispensing device 6 at a lower level than that of the push-button 7 shown in FIG. 1, relative to the level of the end of the neck of the container.

To achieve this, the fastening element 31 shown in FIGS. 5 and 6 has a cylindrical double wall, comprising an outer wall 46 and an inner wall 47 (its function corresponding to that of the hollow shaft 42 shown in the example of FIGS. 1 and 2), the two walls 46 and 47 being coaxial. The two walls 46 and 47 meet a common end 48 (the lower end of each wall 46 and 47 in FIG. 5) and the common end 48 is integral with a coaxial cylinder 49 which extends downwards.

The inner wall 47 has external radial projections 80 that are uniformly distributed around the axis Z of the fastening element 31. The radial projections extend over only a portion of the height of the inner wall 47 and constitute projecting elements forming abutments to retain the projecting element 41 of the skirt 40 of the dispensing device 6.

The cylinder 49, connecting the two walls 46 and 47 together at its end, has an external annular radial groove 52 provided near the end 48, suitable for receiving an O-ring 45 (shown in FIG. 5) to ensure that the assembly is fluidtight.

The body 5 of the dispensing device 6 is suitable for insertion into the central opening 50 defined by the inner wall 47. The space 51 between the inner wall 47 and the outer wall 46 is able to accommodate the outer skirt 11 of the press-fitted pump 6, substantially along the entire height h of the skirt 11.

Because of the space 51 between the two walls, outer 46 and inner 47, the body 5 of the press-fitted pump 6 can thus be further inserted into the fastening element 31 and the total height of the assembly of fastening element 31/dispensing device 6 (press-fitted pump in the present case) is less than that obtained with the fastening element 31 shown in FIGS. 1 and 2.

The cap 60 covering the pushbutton 7 of the dispensing device 6 can therefore be shorter, and made with less material (and therefore more economical to manufacture).

FIG. 8 shows another example of a packaging device 1 according to the second embodiment of the invention, meaning it has a hollow shaft 42 which does not protrude above the upper end of the neck.

This example therefore has similar arrangements to those in the example of FIG. 5. In particular, the fastening element 31 receives and hides the dispensing device 6, positioning the pushbutton 7 at an even lower level than in the preceding examples and embodiments.

The fastening element 31 is mounted on the neck 3 in FIG. 8 and comprises a cylindrical double wall, said double wall comprising an outer wall 46 and an inner wall 47 forming a hollow shaft 42, the two walls 46, 47 being coaxial and joined by their common lower end 48. This common end 48 is integral with a cylinder 49 which extends downwards, hiding the dispensing device 6 in the neck. The dispensing device is, for example, a press-fitted pump 6 mounted on said fastening element 31 as explained for the example of FIG. 5.

The cap 60 covers the pushbutton 7 to protect it, and may be of reduced height, therefore using less material.

FIG. 8 shows additional arrangements, detailed below, which can be adapted to the embodiments and examples previously described.

In addition to the O-ring 45, located here between the outer wall 46 and the neck 3, the packaging device 1 further comprises a flange seal 55 located between the flange 33 and the upper end of the neck. The two seals then form a double seal between the fastening element 31 and the neck 3. The seal or seals 45, 55 may be formed of a material chemically compatible with the product to be dispensed, for example chlorobutyl rubber or silicone. A space 53 of substantially annular shape then exists between said seals 45, 55, the fastening element 31, and the neck 3. This space 53 may contain an adhesive in order to better secure the fastening element 31 to the neck. The seals thus protect this adhesive from the product to be dispensed, such as perfume, ensuring both a better seal and better durability of the seal.

The neck 3 of the bottle 2 possibly comprises a snap-fitting groove 2a formed on the inner face of the neck 3, for example near the upper end of the neck. This groove is advantageously located between the O-ring 45 and the flange seal 55. This snap-fitting groove 2a may be preformed during manufacture of the bottle 2 blank, or formed later by machining, for example using a laser or any other means. Reciprocally, the fastening device 31 comprises at least three clips 44, distributed across an external surface of said fastening device and facing said snap-fitting groove 2a, in order to engage with said groove by extending inside when the fastening device 31 is mounted in the neck 3. This engagement between the snap-fitting groove 2a and the clips 44 ensures a robust mechanical engagement. The attachment between the fastening device 31 and the neck 3 of the bottle 2 is thus improved.

A ring 59 may also be added by force-fitting it between the skirt 11 of the dispensing device 6 and the outer wall 46 of the fastening device 31, to induce outwardly directed radial stress on this outer wall 46. This better ensures radial compression on the O-ring 45, improving the seal. Reciprocally, this ring 59 located between the inner and outer walls may also induce inwardly directed radial stress in order to better secure the dispensing device 6 to the fastening element 31.

Finally, a corner seal 56 may also be provided between the flat locking ring 38 and the fastening element 31 in order to further improve the seal. The flat locking ring 38 in the example of FIG. 8 has a cylindrical portion which extends inside the fastening element 31 and is also attached thereto by peripheral clips of this cylindrical portion, compressing the corner seal 56 to obtain a better seal and a more secure attachment.

The two embodiments illustrated in FIGS. 1, 5, and 8 therefore show that it is possible to design fastening elements 31 where the hollow shaft 42 formed by the inner wall 47 of the fastening element 31 may or may not protrude beyond the flange 33 (extend upward beyond the level of the end of the neck along the Z-axis). A press-fitted pump may be used in both embodiments, because it is simple to press-fit it onto the hollow shaft. However, in order to use a crimp-on pump, the first embodiment where the hollow shaft projects beyond the flange is preferred, because the space available for crimping the metal collar is greater than in the second embodiment. However, in the case of a bottle having a neck of large diameter, it is also possible to use a crimp-on pump in the second embodiment, as long as there is sufficient free space around the hollow shaft.

One will note that the bottle and neck are made of glass in the embodiments described, but the use of other materials remains within the scope of the invention, in particular plastics.

For example, the bottle may be made of opaque material.

The same is true for the material of which the fastening element 31 is made: it may, for example, be made at least partially of metal.

Finally, the O-ring seal is not necessarily fitted on the fastening element but could be created by bi-injection.

1. A packaging device for a product to be dispensed, comprising:
a bottle suitable for containing the product to be dispensed and having a neck comprising an inner wall delimiting an opening,
a dispensing device comprising a body and suitable for dispensing said product,
a fastening element for securing the body of the dispensing device in the neck of the bottle, the fastening element cooperating with the inner wall of the neck of the bottle,
wherein the fastening element comprises a cylindrical double wall comprising an outer wall and an inner wall forming an internal hollow shaft, said outer and inner walls being coaxial, and
wherein said dispensing device comprises a fastening member of said dispensing device, the fastening member being integral with said dispensing device and being fixed around the internal hollow shaft of the fastening element.

2. The device according to claim 1, wherein the inner and outer walls have a common end integral to a cylinder which is coaxial with said walls and which extends downwards.

3. The device according to claim 1, wherein the internal hollow shaft has a retaining element for the fastening member.

4. The device according to claim 3, wherein the retaining element is a bead formed substantially around the hollow shaft.

5. The device according to claim 3, wherein the retaining element is formed by radial projections uniformly distributed around the axis of the hollow shaft.

6. The device according to claim 1, wherein the fastening member is crimped around the internal hollow shaft.

7. The device according to claim 3, wherein the fastening member comprises at least one internal fastening projection, for securing the dispensing device around the internal hollow shaft.

8. The device according to claim 7, wherein said at least one internal fastening projection is formed on an inner face of a ring with radial sections, said ring with radial sections constituting said fastening member and being secured around said body of said dispensing device.

9. The device according to claim 1, wherein the fastening element comprises a cylinder forming a cover for the body of the dispensing device, the cylinder being coaxial with the neck and extending to a height able to conceal said body in the neck.

10. The device according to claim 8, wherein the neck has a neck height and wherein the cylinder extends along the entire neck height.

11. The device according to claim 9, wherein the cylinder has a diameter such that there is empty space between the cylinder and the inner wall of the neck.

12. The device according to claim 1, wherein the fastening element supports a radial O-ring.

13. The device according to claim 12, wherein the radial O-ring is fitted around the fastening element.

14. The device according to claim 13, wherein the element device has a radial groove into which the radial O-ring is inserted.

15. The device according to claim 1, wherein the fastening element comprises a radially projecting flange, said flange comprising a lower surface facing a shoulder provided at the end of the neck.

16. The device according to claim 15, further comprising a flange seal located between the flange and the neck.

17. The device according to claim 11, further comprising a flange seal located between the flange and the neck, wherein an adhesive is placed between the seal and the flange seal to bond the fastening element to the neck.

18. The device according to claim 1, wherein the neck comprises a snap-fitting groove on its inner face, and the fastening element comprises clips facing said snap-fitting groove in order to engage with the snap-fitting groove.

19. The device according to claim 18, wherein the snap-fitting groove is formed in the neck by laser.

20. The device according to claim 1, further comprising a ring force-fitted between the dispensing device and the fastening element.

21. The device according to claim 20, wherein the ring is located between the outer and inner walls of the fastening element.
